(19) United States
(12) Patent Application Publication
(10) Pub. No.: US 2009/0186644 A1
(43) Pub. Date: Jul. 23, 2009

(54) COMMUNICATION METHOD AND RADIO COMMUNICATION APPARATUS

(75) Inventor: Junichi SUGA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawaski (JP)

(21) Appl. No.: 12/333,587

(22) Filed: Dec. 12, 2008

(30) Foreign Application Priority Data
Dec. 14, 2007 (JP) 2007-323901

(51) Int. Cl. H04B 7/00

(52) U.S. Cl. 455/500

(57) ABSTRACT

A communication method for a radio communication system includes a first radio communication apparatus for designating a transmission region and a second radio communication apparatus for transmitting a radio signal in the designated transmission region. The first radio communication apparatus designates a transmission region of data and a control signal for the second radio communication apparatus and designates a type of data to be transmitted in the transmission region. The second radio communication apparatus transmits, in the designated transmission region, transmission data and a control signal indicating that the transmission data is transmitted in accordance with the designated type of data or that the transmission data is not transmitted in accordance with the designated type of data.

### CROSS-REFERENCE TO RELATED APPLICATIONS

This application is based upon and claims the benefit of priority of the prior Japanese Patent Application No. 2007-323901, filed on Dec. 14, 2007, the entire contents of which are incorporated herein by reference.

### FIELD

The embodiments of the present invention discussed herein are related to a communication method and a radio communication apparatus using the radio communication as communication means.

### BACKGROUND

Various communication methods using the radio communication as communication means are known.

FIG. 1 shows an example of the conventional radio communication system. In this system, the radio communication is conducted between a base station BS 1 and a plurality of mobile stations MS 2₁ to 2₃. In this radio communication system, the base station constituting a radio communication apparatus may designate a transmission region for a plurality of mobile stations also constituting radio communication apparatuses.

For example, a base station supplies mobile stations with transmission region designation information for designating the transmission region and receiving region designation information for designating the receiving region for each radio frame. By doing so, the base station can control the transmitting operation and receiving operation of each mobile station for each radio frame, and therefore, the finely detailed control of the radio resources is realized.

Also, in the radio communication system under study by the IEEE802.16 Working Group, a base station designates the transmission region of each mobile station for each radio frame. With reference to FIG. 2, the transmission region designation information and the receiving region designation information used in this radio communication system will be explained (see IEEE Std802.16™-2004 and IEEE Std802.16e™-2005).

FIG. 2 illustrates the structure of the radio frame transmitted from a base station.

The ordinate axis represents the frequency and indicates that the radio frame is transmitted using different frequencies. The abscissa axis represents the time and indicates that the radio frame is transmitted over a given period. Upon complete transmission of this single radio frame, the next radio frame is transmitted. In the next radio frame, different data can be stored, and the section of the transmission region of each burst can also be changed. Preferably, each radio frame is transmitted in such a manner that the preamble is transmitted at given time intervals.

In FIG. 2, the DL sub-frame indicates a downlink sub-frame contained in one radio frame. The direction from the base station to each mobile station is generally called the downlink. The base station uses this downlink sub-frame for transmission. The UL sub-frame, on the other hand, indicates an uplink sub-frame contained in one radio frame. The direction from each mobile station to the base station is generally called the uplink. Each mobile station uses this uplink sub-frame for transmission.

The downlink sub-frame contains a preamble, a DL-MAP, a UL-MAP and one or more downlink bursts (DL bursts No. 1 to 4 in FIG. 2).

The preamble is a signal having a known pattern transmitted in the head of the frame, and each mobile station can detect the head of the frame by detecting the preamble. A preamble of a different pattern can be transmitted from a different base station.

The DL-MAP is the information defining the frequency, the time period, etc. of the data contained in the downlink sub-frame. Each mobile station, by receiving the DL-MAP, can recognize the receiving region information as to which time period and which frequency are to be used for the receiving operation. Thus, DL-MAP can be considered the receiving region designation information for a mobile station. Since a CID (connection identifier) and the receiving region correspond to each other, the mobile station can receive the data in the receiving region specified by the information part of the DL-MAP matching the CID to be received by the mobile station. The mobile station desirous of receiving the data with CID=1, for example, searches the DL-MAP for the transmission frequency and the transmission time period corresponding to CID=1 and performs the receiving operation accordingly. In this way, the mobile station can receive the data transmitted in DL burst No. 1, for example, addressed to the particular mobile station.

The UL-MAP is the information defining the frequency, the time period, etc. of the data contained in the uplink sub-frame. Each mobile station, by receiving the UL-MAP, can recognize the transmission region information as to which time period and which frequency are to be used for transmission operation. Thus, UL-MAP can be considered the transmission region designation information for a mobile station.

With UL-MAP, for example, the mobile station is notified of the frequency and the time period associated with the transmission region (CDMA region) of the ranging code transmitted for network entry, etc.

Moreover, in the case where the base station controls the mobile station communicating with CID=2 to transmit the data with the UL burst No. 2, for example, the UL-MAP containing the frequency and time period information corresponding to the UL burst No. 2 is transmitted in correspondence with CID=2.

As described above, the base station can control the transmission and the receiving operation of each mobile station in detail by transmitting the receiving region designation information and the transmission region designation information to the mobile station for each radio frame.

As described above, the data transmission region may be designated from one radio communication apparatus to another radio communication apparatus in a radio communication system.

Further, at the time of designating the transmission region, designation of the data to be transmitted in the particular transmission region may also be conducted at the same or almost the same time.

By doing so, the radio communication apparatus designating the transmission region can recognize what kind of data is transmitted in the designated transmission region, which contributes to the receiving process of the radio communication apparatus. Inconveniently, however, the radio communication apparatus receiving the designation of the transmission region is unavoidably required to comply with the particular designation of the data to be transmitted in the particular transmission region.

Specifically, in the case where one radio communication apparatus makes a first designation on the first transmission region and the data to be transmitted in the first transmission region, another radio communication apparatus is unavoidably required to transmit the data in accordance with the first designation in the first transmission region. This is by reason of the fact that unless the data is transmitted in accordance with the data designation, an unexpected state may develop in the radio communication apparatus that has made the data designation, thereby causing a problem in the receiving process.

### SUMMARY

According to an aspect of the invention, a communication method for a radio communication system includes a first radio communication apparatus for designating a transmission region and a second radio communication apparatus for transmitting a radio signal in the designated transmission region, wherein the first radio communication apparatus designates a transmission region of data and a control signal for the second radio communication apparatus and also performs designation of a type of data to be transmitted in the transmission region, and the second radio communication apparatus transmits, in the designated transmission region, the transmission data and a control signal indicating that the transmission data is transmitted in accordance with the designation of the type of data or that the transmission data is not transmitted in accordance with the designation of the type of data.

According to an aspect of the invention, a radio communication apparatus, which corresponds to a first radio communication apparatus of a radio communication system wherein a second radio communication apparatus transmits a radio signal in a transmission region designated by the first radio communication apparatus, includes a generating unit configured to generate designation information including a designation of the transmission region of data and a control signal for the second radio communication apparatus, and a designation of a type of data to be transmitted in the transmission region; a transmission unit configured to transmit the designation information generated by the generating unit; and a receiving unit configured to receive transmission data and a control signal indicating that the transmission data is transmitted in accordance with the designation of the type of data or that the transmission data is not transmitted in accordance with the designation of the type of data in the designated transmission region from the second radio communication apparatus.

According to an aspect of the invention, a radio communication apparatus, which corresponds to a second radio communication apparatus of a radio communication system wherein the second radio communication apparatus transmits a radio signal in a transmission region designated by a first radio communication apparatus, includes a receiving unit configured to receive, from the first radio communication apparatus, designation information including a designation of the transmission region of data and a control signal, and a designation of a type of data to be transmitted in the transmission region; a transmission unit configured to transmit a radio signal to the first radio communication apparatus; and a control unit configured to control the transmission unit to transmit, in the transmission region designated by the designation information, transmission data and a control signal indicating that the transmission data is transmitted in accordance with the designation of the type of the data or that the transmission data is not transmitted in accordance with the designation of the type of data.

The type of data may be replaced with a transmission scheme in each aspect above.

Certain objects and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is an example of the conventional radio communication system;

FIG. 2 is an example of the conventional radio frame;

FIG. 3 is an example of the configuration of a radio communication system (first example);

FIG. 4 is an example of the configuration of a radio communication apparatus (base station) (second example);

FIG. 5 is an example of the structure of UL-MAP;

FIG. 6 is an example of the structure of UL HARQ chase sub-burst IE;

FIG. 7 is an example of the structure of UL HARQ flag region allocation IE;

FIG. 8 is an example of the configuration of a radio communication apparatus (terminal) (second example);

FIG. 9 is an example of the retransmission control procedure;

FIG. 10 is an example of the operation flow of the terminal;

FIG. 11 is an example of the operation flow of the base station;

FIG. 12 is an example of the structure of UL HARQ flag allocation region;

FIG. 13 is an example of the relation between UL HARQ chase sub-burst IE and UL HARQ flag allocation region;

FIG. 14 is an example of the structure of UL HARQ chase sub-burst IE; and

FIG. 15 is an example of the relation between UL HARQ chase sub-burst IE and UL HARQ flag allocation region.

### DESCRIPTION OF EMBODIMENTS

Preferred embodiments of the present invention are explained.

In an embodiment, a communication method for a radio communication system including a first radio communication apparatus (10) for designating a transmission region and a second radio communication apparatus (20) for transmitting a radio signal in the transmission region designated by the first radio communication apparatus (10). The first radio communication apparatus (10) designates the transmission region of the data and a control signal and also performs designation of a type of data to be transmitted in the transmission region for the second radio communication apparatus (20), while the second radio communication apparatus (20) transmits, in the designated transmission region, transmission data and a control signal indicating that the transmission data complies or does not comply with the designation of the type of data.

The second radio communication apparatus (20), therefore, can transmit data in the designated transmission region on the one hand and can also transmit the control signal. The first radio communication apparatus (10) can thus be notified by the control signal whether the transmission data complies or does not comply with the designation of the type of data.

Also, even in the case where the data not complying with the designation of the data is transmitted in the designated transmission region, the first radio communication apparatus (10) can recognize the fact, and therefore, can take an appropriate countermeasure in the receiving process.

Further embodiments of the invention will be explained below with reference to the drawings.

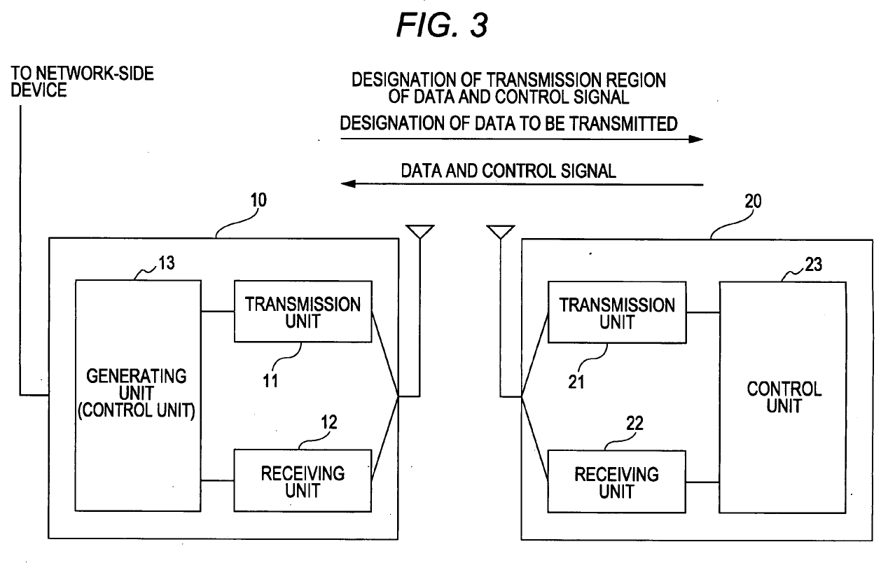

FIG. 3 is an example of a radio communication system according to an embodiment.

In FIG. 3, reference numeral 10 refers to the first radio communication apparatus that designates the transmission region, and numeral 20 refers to the second radio communication apparatus that transmits a radio signal in the designated transmission region.

The first radio communication apparatus 10 includes a transmission unit 11 and a receiving unit 12 connected to an antenna, and a generating unit (control unit) 13. The antenna, the transmission unit 11 and the receiving unit 12 are connected to each other through an antenna duplexer or the like not shown.

The transmission unit 11 transmits the signal received from the generating unit 13 as a radio signal through the antenna. A modulation scheme such as QAM or QPSK can be employed. In the presence of a plurality of second radio communication apparatuses 20, a multiplexing scheme such as CDMA, OFDM (including OFDMA), TDMA or FDMA can be used.

The generating unit (control unit) 13 controls the transmission unit 11 and the receiving unit 12 while generating a signal transmitted to the second radio communication apparatus 20.

Specifically, the generating unit 13 designates the transmission region of the data and the control signal while at the same time generating the designation information for designating the type of data to be transmitted in the transmission region and supplies the particular information to the transmission unit 11.

The receiving unit 12 executes the receiving process for the radio signal received from the antenna, and applies the receiving execution result to the generating unit (control unit) 13.

The second radio communication apparatus 20, on the other hand, includes a transmission unit 21 and a receiving unit 22 connected to an antenna, and a control unit 23. The antenna is connected to the transmission unit 21 and the receiving unit 22 through an antenna duplexer not shown.

The transmission unit 21 transmits, through the antenna, the signal received from the control unit 23 as a radio signal. A modulation scheme such as QAM or QPSK can be employed. In the presence of one or more second radio communication apparatuses 20, a multiplexing scheme such as CDMA, OFDM (OFDMA), TDMA, or FDMA can be used.

The control unit 23 controls the transmission unit 21 and the receiving unit 22 while generating a signal to be transmitted to the first radio communication apparatus 10.

The receiving unit 22 executes the receiving process for the radio signal received from the antenna, and supplies the receiving execution result to the control unit 23.

As described above, the first radio communication apparatus 10 transmits the designation information generated by the generating unit 13. The receiving unit 22 receives this designation information and supplies the receiving execution result to the control unit 23. The control unit 23 analyzes the designation information contained in the received signal and determines how to control the transmission unit 21. Specifically, the transmission unit 21 is controlled so as to transmit the signal in the transmission region designated by the designation information. In the case where the designation information includes the transmission frequency (or a plurality of frequencies such as OFDMA) and the time period, the transmission unit 21 is instructed to transmit the signal at the designated frequency in the designated time period.

The control unit 23 analyzes not only the designation of the transmission region but also the designation of the type of data to be transmitted in the particular transmission region, and controls the transmission unit 21 to transmit the data in accordance with the data designation. The designation may include the designation of the type of data, such as control data, user data, audio data, video data, data high in priority, new data, and retransmission data or the like. The designation may be a transmission scheme (modulation scheme, coding rate) to be adapted to transmission of the second radio communication apparatus, etc.

The control unit 23 normally supplies the designated type of the data and/or the designated transmission scheme to the transmission unit 21. In the process, the control unit 23 may supply the transmission unit 21 with a control signal (C1) indicating that transmission data to be transmitted is in accordance with the designation. In such a case, data complying with the designation of the data and the control signal (C1) are transmitted from the transmission unit 21 in the designated transmission region. The data and the control signal (C1) may of course be supplied in a set to the transmission unit 21. As an alternative, the control unit 23 may notify the transmission unit 21 of the compliance with the designated data type by not transmitting the control signal (C2) indicating that the data is not of the designated type. The data may be transmitted in accordance with the designated transmission scheme.

In the case where the transmission scheme is designated, the control unit 23 instructs the transmission unit 21 to transmit the data in the designated transmission scheme, and the transmission unit 21 transmits the data in the particular scheme designated. In the process, the control signal C1 is transmitted. The control signal C1 may be the information indicating the transmission scheme of the data actually transmitted.

In some cases, a type of data different from the designated type of data may be supplied to the transmission unit 21. In such a case, the control unit 23 sends the control signal (C2) indicating that the data is of a type other than the type designated by the designation information and the particular different type of the data to the transmission unit 21 for transmission. The control signal C2 may be the information indicating that the data type, though transmitted in the designated transmission region, does not to comply with the designation of the type of data.

In the case where the control signal C1 is transmitted when data complying with the designated type of data is transmitted, the first radio communication apparatus 10 can be notified, by not receiving the control signal C1, that the data is not of the designated type. Regardless of whether the control signal C1 is transmitted or not when data complying the designation of the type of data is transmitted, the control signal C2 may be transmitted to notify that data transmitted does not comply with the designation of the type of data. Nonetheless, the first radio communication apparatus 10 can be informed that the type of data transmitted is not of the designated type.

In the case where the transmission scheme is designated, if the control unit 23 instructs the transmission unit 21 to transmit data in a transmission scheme different from the designated one, then the control unit 23 makes the transmission unit 21 transmit the control signal C2. The control signal C2 may be the information indicating the actual transmission scheme not complying with the designated transmission scheme. In changing the transmission scheme, a transmission scheme is desirably selected which reduces the radio resource region required for transmission. The transmission scheme is changed, for example, to 16 QAM from the designated QPSK. This may permit a greater amount of information to be transmitted in the designated region. Of course, the reverse is also adapted. In the case where the second radio communication apparatus 20 has a measurement unit (CINR measurement unit, SIR measurement unit, or level measurement unit) for measuring the radio environment with the first radio communication apparatus 10, the transmission scheme may be changed in accordance with the radio environment. Improving the quality changes the transmission scheme to a faster one, while reducing the quality changes the transmission scheme to a slower one.

The control unit 23 controls the transmission unit 21 to transmit the data different from the designated data type and the control data C2 in the transmission region designated by the designation information. As an alternative, the control unit 23 controls the transmission unit 21 to transmit the control signal C2 together with the data in a transmission scheme different from the designated one in the transmission region designated by the designation information.

The control signals C1 and C2 themselves are desirably transmitted in a given transmission scheme or a designated transmission scheme designated by the first radio communication apparatus.

The control unit 13 of the first radio communication apparatus 10 controls the receiving unit 12 to execute the receiving process in a frequency and time period corresponding to the transmission region designated by the designation information, and thus receives the data transmitted in compliance or not in compliance with the designation of data type or transmission scheme. Also, the control unit 13 detects the receipt of the data transmitted in accordance with the designation in the designation information by receiving the control signal C1 or by not receiving the control signal C2, and detects the receipt of the data not transmitted in accordance with the designation in the designation information by receiving the control signal C2 or by not receiving the control signal C1.

The C1 or C2 may be received by a given transmission scheme or a designated transmission scheme designated by the first radio communication apparatus.

As described above, the first radio communication apparatus 10, even upon receipt of the data transmitted without complying with the designation, is capable of detecting the receipt of the particular data, and therefore, the second radio communication apparatus 20 is permitted to transmit data different from the designated data.

The first radio communication apparatus 10 can execute a different process in accordance with the detection.

In the case where transmission of the retransmission data is designated and compliance with the designation is detected, for example, the received data can be handled as the retransmission data and can be decoded after being synthesized with the previous data that could not be received correctly. In this way, synthesized gain is obtained and the receiving characteristics can be improved. As an alternative, without being synthesized with the previous data that could not be received, the received data may be handled as retransmission data to replace the data that could not be received that is discarded.

Upon detection of an incompliance with the designation, on the other hand, the received data is not retransmission data, but new data, and therefore, handled as data other than the previous data that could not be received, and the process of decoding by synthesizing the new data with the previous data that could not be received may be prohibited.

The first radio communication apparatus 10 can also execute a different process in accordance with the detection. In the case where the control signal C2 is received in spite of the designation of the transmission scheme of 16 QAM, for example, the data can reproduced normally by trying to execute the receiving process in accordance with another demodulation scheme such as QPSK instead of 16 QAM. If the transmission scheme is notified by the control signal C2, the first radio communication apparatus 10 can save the labor of testing the receiving processes of all the possible transmission schemes .

The transmission timing of the control signal may or may not be within the same radio frame (UL sub-frame) as the corresponding data. In the case where the control signal is transmitted in the radio frame ahead of the data, the first radio communication apparatus 10 can make preparation for the receiving process. A control signal, transmitted in the same radio frame, on the other hand, can be used to determine the method of processing the data received in the same time period. In the case where the control signal (C2) is transmitted later than the radio frame for data transmission, on the other hand, the first radio communication apparatus 10 can execute a different receiving process on the received data afterward based on the control signal received later. For example, the received signal may be provisionally stored in a storage unit, and upon receipt of the control signal C2, the receiving process can be retried in a receiving scheme different from the designated receiving scheme (QAM). Also, in the case where the received data and the retransmission data are synthesized with each other and the retransmission data is designated, two types of the received data (provisional retransmission data) expected to be retransmitted are prepared. Specifically, both the provisional retransmission data before synthesis in the synthesis unit and the provisional retransmission data after synthesis with the previously received data are stored in the storage unit, so that upon subsequent receipt of the control signal C2, the provisional retransmission data is recognized as new data, and the data before synthesis is sent from the storage unit to the generating unit 33 as new data.

The control signals C1 and C2 are transmitted in a given or designated transmission scheme, and received in a receiving scheme corresponding to the given or designated transmission scheme designated by the first radio communication apparatus, as the case may be.

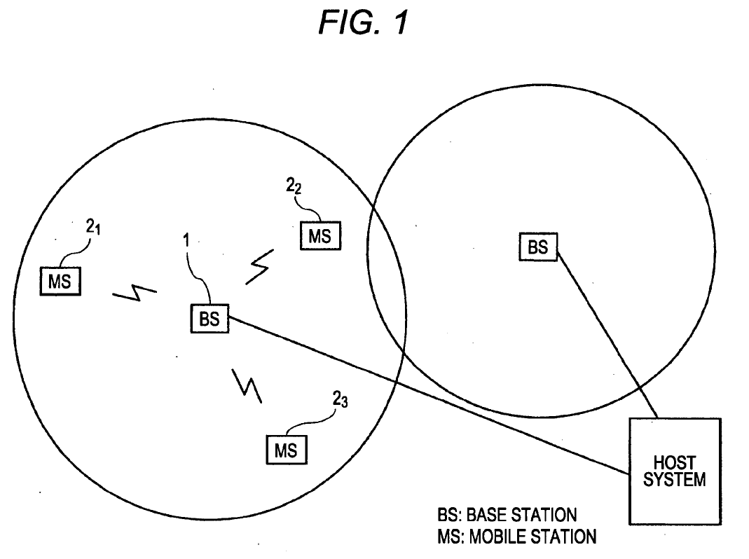

The case under consideration represents a situation in which the first and second radio communication apparatuses 10 and 20 are in a one to one relationship. Nevertheless, a plurality of second radio communication apparatuses 20 may exist as shown in FIG. 1, or the first radio communication apparatus 10 may be further connected to network-side devices and operate as a base station forming a cell in a cellular system. The use as a base station corresponding to a base station in IEEE802.16d/e is another example.

Next, an explanation will be given about a case in which a base station corresponding to a base station in IEEE802.16d/e is used in a basic configuration according to this invention. A mobile station (MS) can be replaced with a fixed apparatus (Subscriber station (SS)), and therefore, is called a terminal in this case.

The configuration shown in FIG. 1 can be employed for the system as a whole. The base station (BS) can be connected to a terminal through a relay station (RS), in which case BS should be read as RS.

As shown in FIG. 1, each BS makes up a cell constituting a radio area in which radio service is provided to the terminal. Each BS is connected with a host apparatus (system) and adapted to communicate with other BS or network-side devices.

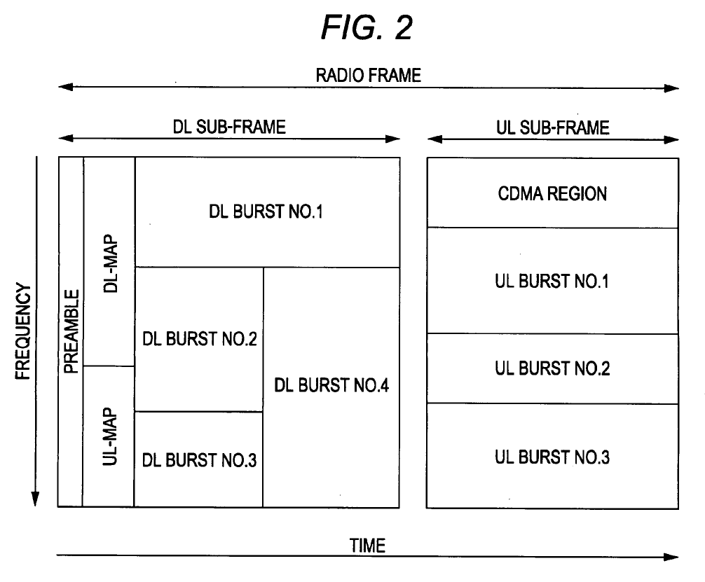

According to this embodiment, the radio frame can use the format shown in FIG. 2. According to this embodiment, therefore, the base station transmits the DL sub-frame and receives the UL sub-frame shown in FIG. 2. The transmission region and the transmission scheme (modulation scheme, coding rate, repetition number, etc.) of the DL burst and the UL burst are defined by DL-MAP and UL-MAP, respectively, as described above.

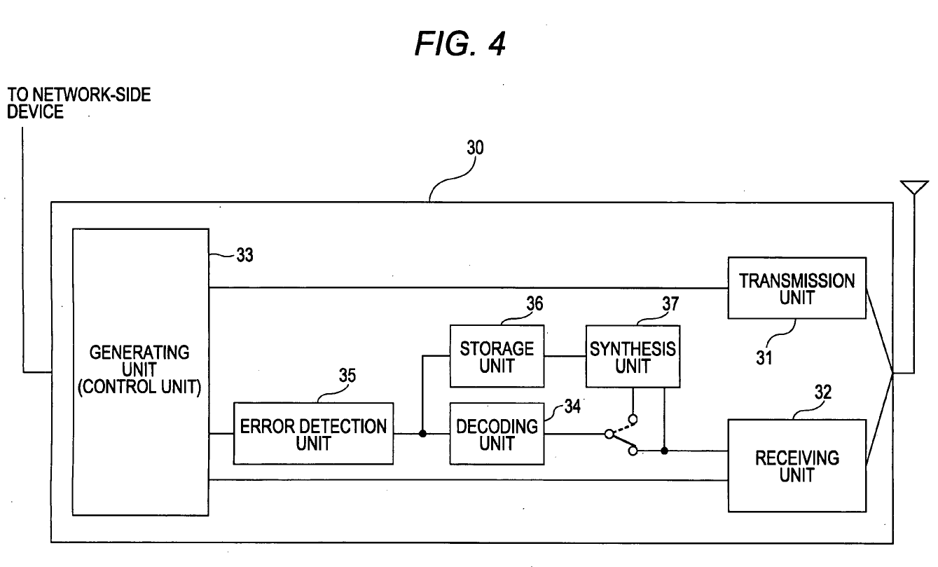

Now, the configuration of the base station will be explained with reference to FIG. 4.

The base station 30 includes a transmission unit 31, a receiving unit 32, a generating unit (control unit) 33, a decoding unit 34, an error detection unit 35, a storage unit 36, and a synthesis unit 37.

The generating unit (control unit) 33 generates a preamble, DL-MAP, UL-MAP, and each DL burst forming a radio frame, and controls the transmission unit 31 to transmit them. The DL-MAP defines the transmission region and the transmission scheme of each DL burst, and the generating unit (control unit) 33 controls the transmission unit 31 to transmit each DL burst in the transmission region and transmission scheme defined by DL-MAP. The UL-MAP, on the other hand, defines the transmission scheme and the transmission region for each UL burst and the ranging signal (CDMA region).

In the case where the transmission of the control signals C1 and C2 in the same region as the data is permitted as explained above, the transmission region of the data and the control signal are designated collectively in accordance with the UL-MAP information defining the transmission region of the uplink data.

In the case where the transmission of the control signals C1 and C2 in a different region than the data is permitted as described above, on the other hand, the data transmission region and transmission scheme are designated by the UL-MAP information (UL-MAP for data transmission) defining the uplink data transmission region, while the transmission region and the transmission scheme of the control signal are designated by another UL-MAP information (UL-MAP for control signal transmission) defining the control signal transmission region. The ranging signal is a kind of control signal and the transmission region thereof may be defined according to the UL-MAP for the control signal transmission.

Nonetheless, the fact remains unchanged that the transmission region of the data and the control signal are designated by UL-MAP.

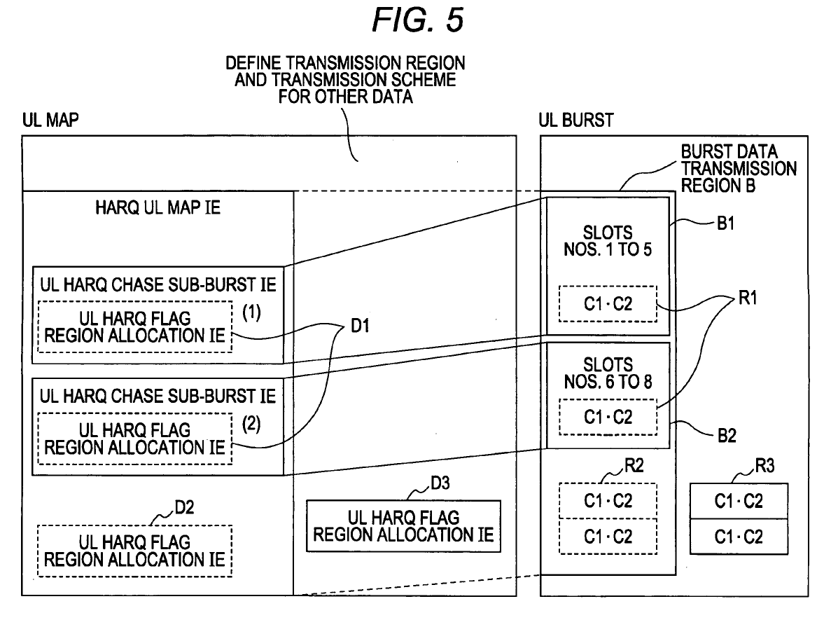

FIG. 5 is an example of the data structure of a UL-MAP. In this case, the data for which the transmission region is designated is assumed to be the data controlled for retransmission.

HARQ (Hybrid Automatic Repeat reQuest) UL MAP IE (Information Element) defines the transmission region (transmission block) of the data to be controlled for retransmission. For example, a particular frequency and a particular time period in the UL sub-frame to which the transmission of the data to be controlled for retransmission is allocated are defined.

The transmission region allocated by HARQ UL MAP IE can be used by being further subdivided according to a UL HARQ Chase sub-burst IE.

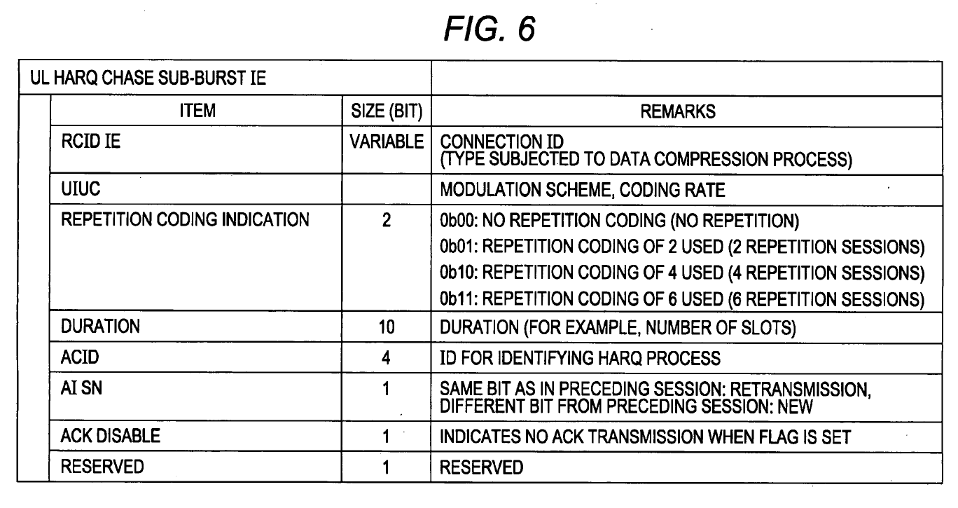

A UL HARQ Chase sub-burst IE may have the data structure, for example, shown in FIG. 6.

The data items may include RCID (Reduced Connection IDentifier) IE, UIUC (Uplink Interval Usage Code), Repetition Coding Indication, Duration, ACID (hARQ Channel IDentifier), AI SN (hARQ Identifier Sequence Number), ACK disable, and Reserved. FIG. 6 shows the structure of HARQ UL MAP IE using the CC (Chase Combine) scheme. The IR (Increment Redundancy) scheme, the CTC (Convolutional Turbo Code) scheme, or the IR CC (Convolutional Code) scheme may also be employed.

RCID IE is the ID information for specifying the connection between the base station 30 and the terminal 40. In this case, the RCID subjected to a given data compression process can be used.

UIUC is the information for specifying the transmission scheme such as the modulation scheme (QPSK, 16 QAM, etc.) and/or the coding rate (½, ⅓, etc.). A different numerical value may be allocated to each set of modulation schemes and coding rates, and any of the numerical values can be used (transmitted) as UIUC information.

“Repetition Coding Indication” is the information for controlling the redundancy of the transmission data stored in the UL burst. For example, the number of repetitions of the transmission data can be set to nil by 0b00, to 2 by 0b01 (two identical transmission data are stored), to 4 by 0b10 (four identical transmission data are stored), and to 6 by 0b11 (six identical transmission data are stored).

“Duration” indicates the period during which the data is transmitted, and for example, can be indicated in terms of the number of slots permitting the transmission. HARQ UL MAP IE can contain a plurality of UL HARQ chase sub-burst IEs, and therefore, the terminal 40 first specifies the transmission region designated by HARQ UL MAP IE. Then, in the case where the terminal 40 transmits the data in accordance with the second UL HARQ chase sub-burst IE (2), the data is shifted by the number (5, in this case) of slots designated by “Duration” of the first UL HARQ chase sub-burst IE (1), and transmitted using the three slots designated by “Duration” of UL HARQ chase sub-burst IE (2) from the sixth slot. Specifically, in the case where the terminal 40 transmits the data in accordance with Nth UL HARQ chase sub-burst IE, the total “Duration” of the first to (N−1)th UL HARQ chase sub-burst IEs is determined and transmission of the data is started from the (total+1)th slot. In the case where the UL HARQ chase sub-burst IE includes the information stating how many slots can be used after a particular slot for data transmission, the terminal may specify the data transmission region by receiving a single UL HARQ chase sub-burst IE addressed to the terminal without receiving other UL HARQ chase sub-burst IEs.

The data transmission region may be designated for each radio frame.

ACID is the information indicating the ID for identifying the retransmission control (HARQ) process. In the case where the terminal 40 transmits the data in parallel, for example, different ACIDs are allocated to different transmission data. In this way, each transmission session can be distinguished so that the retransmission control can be performed for each transmission session.

AI SN can use bits of 0 and 1, for example. AI SN, if set to “1 (0)” for the previous transmission session, for example, is also set to the same “1 (0)” if retransmission is required for the current transmission session, while it is set to a different “0 (1)” if a new transmission is required. With the bit change, therefore, the new transmission or the retransmission is notified to the terminal 40. Thus, the terminal 40 identifies the new transmission or the retransmission using both the previous and current bits.

“ACK disable” is the information notifying that HARQ ACK IE is not transmitted for the data received from the terminal 40.

“Reserved” is a reserved empty information region.

Also, the base station 30 secures the transmission region where the terminal 40 can transmit the control signals C1 or C2.

In the process, the transmission region of the control signals (C1, C2) can be determined as described below.

(1) In the transmission region (B) of the burst data designated by HARQ UL MAP IE

First Case:

In this case, the transmission of the control signal in the transmission region of each burst data is permitted.

The transmission region of the control signals (C1, C2) can be set in each region indicated by R1 in FIG. 5.

By doing so, the base station 30 can efficiently receive both the data and the control signal by executing the receiving process for the transmission region of each burst data.

A specific region R1 can be designated by any one of D1 (in the designation data for designating each burst data), D2 (in the designation data for designating the whole of the burst data transmission region), or D3 (outside the data for designating the burst data transmission region). D1, D2, or D3 may be transmitted for each radio frame or each plurality of radio frames.

Also, D1 expressly designates the transmission region where the control signal is to be transmitted in each burst data transmission region. The base station 30, however, can also designate the transmission region of each burst data, while the terminal 40, by interpreting the designated burst data transmission region as the transmission region of the data and the control signal, can transmit the data and the control data. Specifically, in spite of the designation “in the burst data region,” a specific part in the burst data region (B) in which the control signal is to be transmitted is not designated.

Second Case:

In this case, the transmission of the control signal in the transmission region of individual burst data is not permitted and the transmission region of the control signals (C1, C2) are set in the region indicated by R2 in FIG. 5.

By doing so, the control signals are transmitted in a transmission region different from that of the data controlled for retransmission. Thus, the radio environment for data transmission can be different from the radio environment for transmission of the control signals. The base station 30, which may be unable to receive the data, can receive the control signals.

A specific region R2 can be designated by any of D1 (in the designation data for designating each burst data), D2 (in the designation data for designating the whole of the burst data transmission region), or D3 (outside the data for designating the burst data transmission region) shown in FIG. 5. D1, D2, or D3 may be transmitted for each radio frame or each plurality of radio frames.

Also, D2 expressly designates the burst data transmission region and, in particular, to which transmission region the control signal is to be transmitted. The base station 30, however, may designate the burst data transmission region B without setting D2, and the terminal 40 can transmit the control signal by interpreting the part (remaining part) of the burst data transmission region B not used for data transmission, as a control signal transmission region.

(2) Outside the burst data transmission region (B) designated by HARQ UL MAP IE

The transmission region for the control signals (C1, C2) may be set in the region indicated by R3 in FIG. 5.

By doing so, the transmission region for the control signals can be differentiated from the transmission region for the data subjected to retransmission control, and therefore, the radio environment for data transmission is different from the radio environment for transmission of the control signals. Thus, the base station 30, though unable to receive the data, can receive the control signal. Also, a region more distant from the data transmission region can be designated as a control signal transmission region, and therefore, the radio environments may become more different from each other.

The region R3 can be designated by any of D1 (in the designation data for designating each burst data), D2 (in the designation data for designating the whole of the burst data transmission region), or D3 (outside the data for designating the burst data transmission region) shown in FIG. 5. D1, D2, or D3 may be transmitted for each radio frame or each plurality of radio frames.

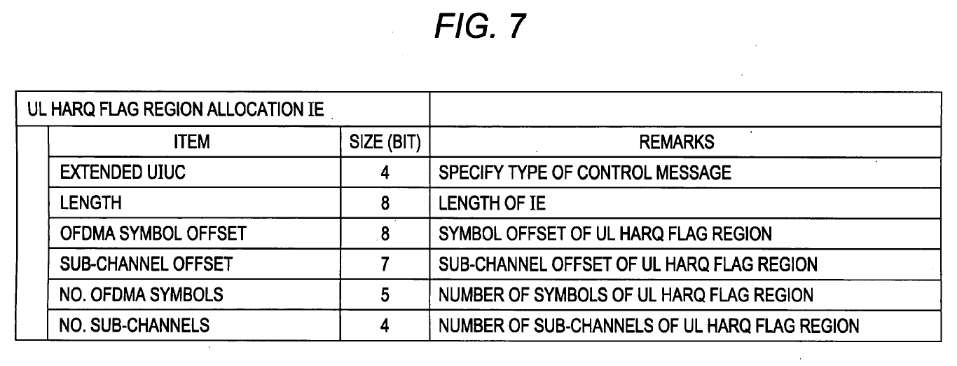

FIG. 7 is an example of the designation information for designating the transmission region of the control signal by D1, D2, and D3. In this case, the designation information for designating the transmission region of the control signal is referred to as UL HARQ flag region allocation IE.

UL HARQ flag region allocation IE includes Extended UIUC, Length, OFDMA symbol offset, Subchannel offset, No. of OFDMA symbols, and No. of subchannels.

Extended UIUC is the information indicating the message type and a message defining the transmission region of the control signal.

“Length” indicates the length of the message.

OFDMA symbol offset, Subchannel offset, No. of OFDMA symbols, and No. of subchannels are information defining the transmission region in which the control signal is to be transmitted. OFDMA symbol offset indicates the number of symbols delayed behind the reference timing (for example, the head of the preamble, the start timing of the DL MAP or the start timing of DL burst or the like) in the radio frame at which the control signal transmission region is started (start timing). Similarly, Subchannel offset indicates the number of subchannels distant from one end of the subchannel in use from which the control signal transmission region is to be started (start subchannel). No. of OFDMA symbols indicates the number of symbols for which the control signal transmission region continues as counted from the start timing. No. of subchannels indicates the number of subchannels for which the control signal transmission region is continued from the start subchannel.

The designation of the transmission region is not limited to the foregoing cases.

The receiving unit 32 of the base station 30 receives the data (for example, the data and the control signals (C1, C2) transmitted in the UL burst area) from the terminal 40. The receiving unit 32 receives the signal (which is transmitted by the UL sub-frame in the radio frame that has transmitted a UL-MAP, or after a given number of frames, for example, the UL sub-frame of the next radio frame, from the UL sub-frame in the radio frame that has transmitted a UL-MAP) transmitted from each terminal 40 in the transmission region designated by HARQ UL MAP IE, in the receiving scheme corresponding to the transmission scheme designated by each UL HARQ chase sub-burst IE.

In the case where a new transmission is set by AI SN, the receiving unit 32 applies the transmission data from the terminal 40 to the decoding unit 34 (for example, an error correction decoder such as a turbo decoder) so that the decoding result is stored in a storage unit 36 while an error detection unit 35 (CRC check unit, etc.) detects an error.

In the case where the error detection unit 35 detects no error, the data stored in the storage unit 36 is discarded (made overwritable) and the received data is applied to the generating unit (control unit) 33. In the process, the error detection unit 35 desirably applies the received data containing an identification bit indicating the receiving success.

The generating unit (control unit) 33, upon detection of the receiving success, collects the received data of the same connection based on RCID, and combines them, if required. The combined data may be transferred to the host system at a given address on the network side to execute communication between the terminal 40 and a particular communication partner apparatus.

Also, the generating unit 33 can judge that the retransmission is not required due to the receiving success, and therefore, executes the bit change process on AI SN, but not on RCID or ACID, to indicate the new transmission thereby to generate UL HARQ chase sub-burst IE. By transmitting UL HARQ chase sub-burst IE in the next radio frame, the same terminal 40 can be prompted to transmit the next data as the same process. The transmission region, etc. may be reset by HARQ UL MAP IE. The transmission region of the UL burst data may be changed by HARQ UL MAP IE.

Now, in the case where the error detection unit 35 detects an error, the erroneous data is stored in the storage unit 36 corresponding to RCID or ACID. The error detection unit 35 notifies the generating unit (control unit) 33 of the error with RCID or ACID so that the generating unit 33 executes the process of changing the bits to indicate the retransmission for AI SN but not for RCID or ACID. Thus, UL HARQ chase sub-burst IE is generated and transmitted in the next radio frame. In this way, the same terminal 40 can be prompted to retransmit the data as the same process. The transmission region, etc. may be reset by HARQ UL MAP IE.

In the case of retransmission, the receiving unit 32 receives the retransmitted data and applies the received data to the synthesis unit 37. The synthesis unit 37, notified of the received data in RCID or ACID from the generating unit 33, reads the corresponding data from the storage unit 37, synthesizes it with the received data retransmitted, and applies the synthesis result to the decoding unit 34. The synthesis is executed at the signal level (for example, maximum ratio synthesis) by the process of averaging the degree of signal certainty (likelihood), etc.

The decoding unit 34 decodes the signal based on the synthesis data, and applies the decoding result to the error detection unit 35 and the storage unit 36 in preparation for another retransmission.

The subsequent operation of the error detection unit 35 is similar to the one described above.

As described above, this base station 30 is configured so as to obtain the synthesis gain by synthesizing the retransmission data with the data that could not be received correctly, thereby suppressing the number of retransmission sessions. The generating unit 33 however, may decode again the data retransmitted without being synthesized, and if there is no error, can control the terminal 40 to transmit new data. While if there is an error, the generating unit 33 can control the terminal 40 to retransmit the retransmission data.

Also, the receiving unit 32 of the base station 30 receives the control signals (C1, C2) as well as the data from the terminal 40, and supplies the receiving result to the generating unit (control unit) 33.

The generating unit 33, upon receipt of the control signal (C1) (without receiving the control signal C2) indicating the correspondence of the data to the data designated by the designation information, executes the process planned by designation.

In the case where the designation information designates the transmission of the retransmission data, for example, the received signal of the retransmitted data is supplied to the synthesis unit 37 as planned, and by being synthesized with the signal stored in the storage unit 36, is decoded again.

Also, the generating unit 33, upon receipt of the control signal (C2) (without receiving the control signal C1) indicating that the data not corresponding to the one designated by the designation information, executes a process different from the one planned by designation.

In the case where the transmission of the retransmission data is designated by the designation information, for example, the received signal for the transmitted data (for example, new data) different from the designated retransmission data is not synthesized as planned but sent to the decoding unit 34. The decoding unit 34 applies the decoding result to the generating unit 33 through the error detection unit 35.

As described above, the use of the control signals C1 or C2 secures the proper operation of the base station 30 even in the case where data different from the designated data is transmitted.

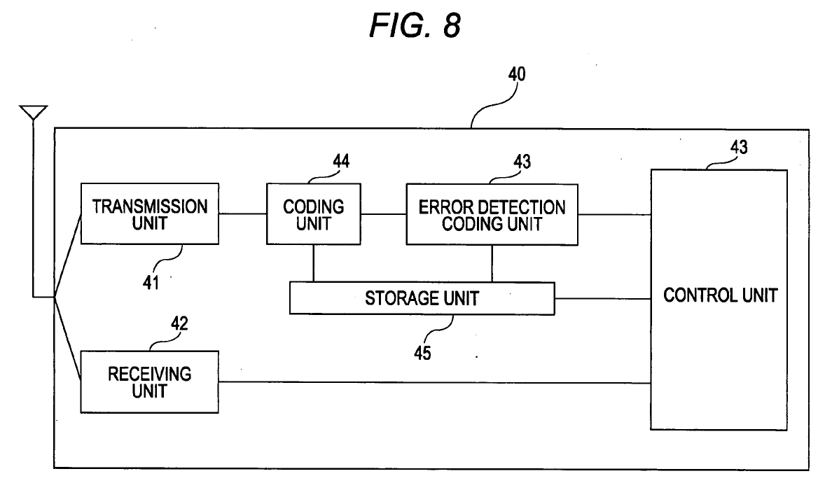

FIG. 8 is an example of the configuration of the terminal as an example of a radio communication apparatus.

In FIG. 8, numeral 40 designates a terminal, numeral 41 a transmission unit, numeral 42 a receiving unit, numeral 43 an error detection coding (encoding) unit, numeral 44 a coding (encoding) unit, and numeral 45 a storage unit.

The receiving unit 42 receives UL-MAP and DL-MAP concurrently with the radio frame timing using the preamble transmitted from the base station 30.

The control unit 43 of the terminal 40, upon receipt of the information on the transmission scheme and the transmission region of the DL burst corresponding to CID to be received by the terminal 40, controls the receiving unit 42 to receive the information transmitted from the base station 30 in the particular transmission region and the particular transmission scheme. The data received by the receiving unit 42 is supplied to the control unit 43 and processed as required. The received data (for example, audio or video information) thus processed as required is output from a display unit or, as the case may be, an audio output unit not shown.

Also, the receiving unit 42, receives the ranging signal transmission region defined in UL-MAP. The receiving unit 42 receives the HARQ UL MAP IE (especially, the MAP information addressed to itself) defined in UL-MAP when there is transmission data subject to retransmission control.

The ranging region may be used for transmitting the ranging signal used for entry into the network or controlling the transmission timing and the transmission frequency of the radio signal transmitted by the mobile station. In the ranging region, which is shared by other terminals, a signal conflict may occur in the case where the same or similar timing is selected by other terminals. By using a selected one of a plurality of CDMA codes, however, the code can be separated to some degree. By using different codes, therefore, simultaneous transmission also be allowed.

The received HARQ UL MAP IE data is analyzed by the control unit 43 and used for specifying the burst data transmission region and the part of the particular burst data transmission region to which the data is to be transmitted.

Specifically, in the case where the RCID corresponding to the terminal 40 is stored in the UL HARQ chase sub-burst IE (2) contained in the HARQ UL MAP IE, the control unit 43 of the terminal 40 specifies the slots #6 to #8 in the burst transmission region as the data transmission region according to the method described above, and controls the transmission unit 41 to transmit the data in the particular region. Any of the transmission data before the error detection coding, after the error detection coding, or after coding (after error correction coding such as turbo coding) is stored in the storage unit 45 in preparation for retransmission. The transmission data is stored corresponding to ACID. In retransmission, the stored signal is read from the storage unit 45 and supplied to the corresponding unit to execute the remaining processes requiring execution.

Also, in the case where the RCID corresponding to the control unit 43 is stored in the UL HARQ chase sub-burst IE (2) in the HARQ UL MAP IE and AI SN remains unchanged from AI SN previously received, then the control unit 43 detects the requirement of retransmission, and reads the data corresponding to ACID contained in the same UL HARQ chase sub-burst IE and causes the transmission unit 41 to transmit the particular data in the designated transmission region and transmission scheme.

In the case where the RCID corresponding to the terminal 40 is stored in the UL HARQ chase sub-burst IE (2) in the HARQ UL MAP IE and AI SN is changed from AI SN previously received, the control unit 43 detects the designation of the new transmission and causes the transmission unit 41 to transmit new data. The new data is transmitted also in the designated transmission region and transmission scheme.

Also, the terminal 40, when transmitting the data corresponding to the designated data type to the base station 30, transmits the control signal C1 in the designated control signal transmission region (the control signal C2 is not transmitted). On the other hand, the terminal 40, when transmitting the data not corresponding to the designated data type to the base station 30, transmits the control signal C2 in the designated control signal transmission region (the control signal C1 is not transmitted).

There may be various situations where data which is not designated is transmitted to the base station 30.

When the terminal 40 transmits the high application data in real time such as voice of IP (VoIP) data or video phone data, for example, and a tolerable delay time is exceeded, it may not be practicable to transmit such data from the terminal 40.

An example is a case in which a normal transmission is not complete yet due to a receiving failure in the base station 30 regardless of whether or not the VoIP data has exceeded the time limit of the transmission.

Even in the case where the data contains the time limit information, the base station 30 failing to receive the data cannot confirm the particular information. Therefore the base station 30 requests the terminal 40 for retransmission. In response to the retransmission request, on the other hand, the terminal 40 may wastefully try the retransmission and may transmit the data that no longer requires the retransmission. If no data is transmitted from the terminal 40, however, the transmission region designated for retransmission would be wasted.

The terminal 40, therefore, desirably transmits data different from the designated retransmission data. This is because the different data is higher in priority than the low value retransmission data.

The terminal 40, in transmitting the data different from the designated data in spite of the retransmission control, transmits the control signal (C2) indicating the fact that the data is different or the type of the data is different in the designated control signal transmission region. Thus, the base station 30 can avoid trouble which otherwise might be caused by the unexpected data reception.

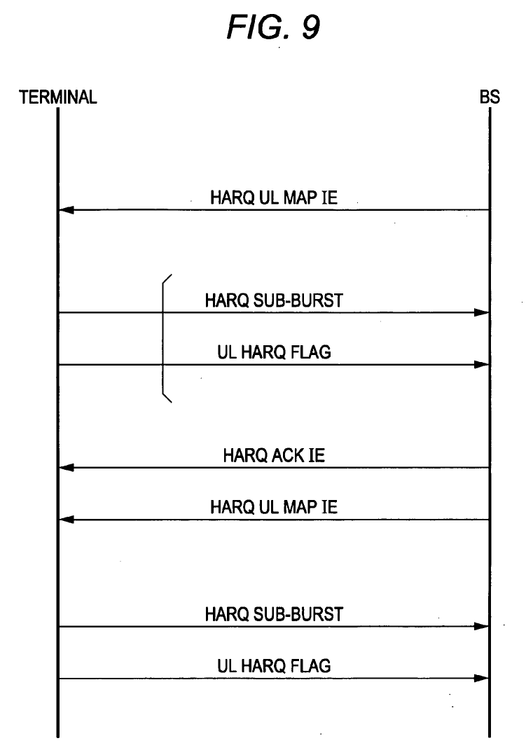

FIG. 9 is an example of a procedure for retransmission control.

The base station 30 designates the transmission region of the data and the control signal and the data (new data and/or retransmission data) to be transmitted in the particular transmission region by HARQ UL MAP IE (UL HARQ chase sub-burst IE).

The terminal 40 transmits the data designated by HARQ sub-burst or the data different from the designated data in the designated transmission region, while at the same time transmitting the corresponding control signals (C1, C2) as UL HARQ flags in the control signal transmission region. The data and the control signals are desirably transmitted in the same UL sub-frame to reduce the process delay.

The base station 30 notifies the terminal whether the signal can be received or not, as required, according to HARQ ACK IE.

Also, the base station 30 requests the terminal to transmit the new data or the retransmission data by HARQ UL MAP IE (UL HARQ chase sub-burst IE).

The terminal 40 transmits the data designated by HARQ sub-burst or the data different from the designated data in the designated transmission region, while at the same time transmitting the corresponding control signals (C1, C2) as UL HARQ flags in the control signal transmission region.

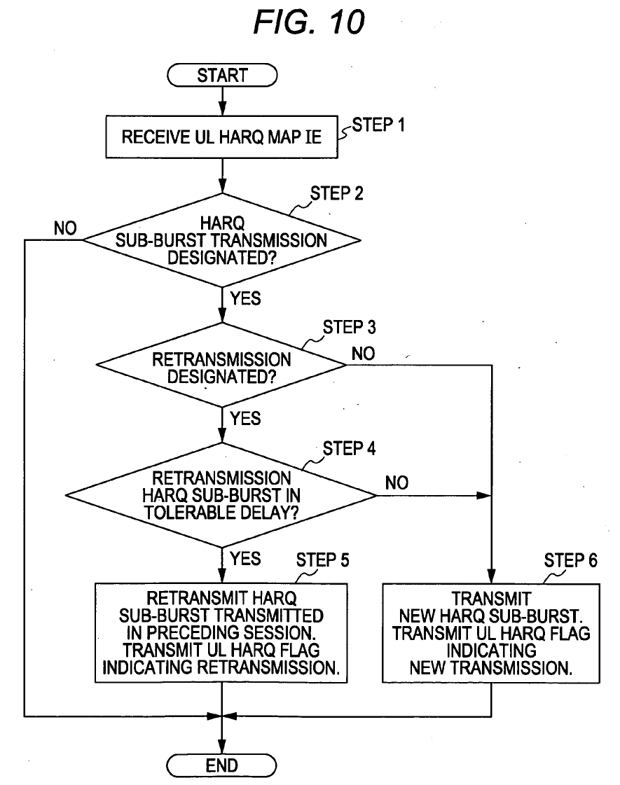

FIG. 10 is an example of the operation flow of the terminal.

The terminal 40 receives the UL HARQ MAP IE (step 1).

The terminal 40 judges whether the transmission of HARQ sub-burst to itself is designated or not (step 2). In the case where the answer is NO, the process is ended and returns to the start.

In the case where the answer is YES in step 2, the terminal 40 judges whether the retransmission is designated or not (step 3).

In the case where the retransmission is designated, the terminal 40 judges whether the HARQ sub-burst for retransmission is within the tolerable delay time (whether the designated data is to be transmitted or not) (step 4).

If the tolerable delay time is within the tolerance, the HARQ sub-burst transmitted in the preceding session is retransmitted while at the same time transmitting the control signal C1 as UL HARQ flag (without transmitting the control signal C2) (step 5).

If the tolerable delay time exceeds the tolerance, the new HARQ sub-burst is transmitted while at the same time transmitting the control signal C2 as UL HARQ flag (without transmitting the control signal C1) (step 6).

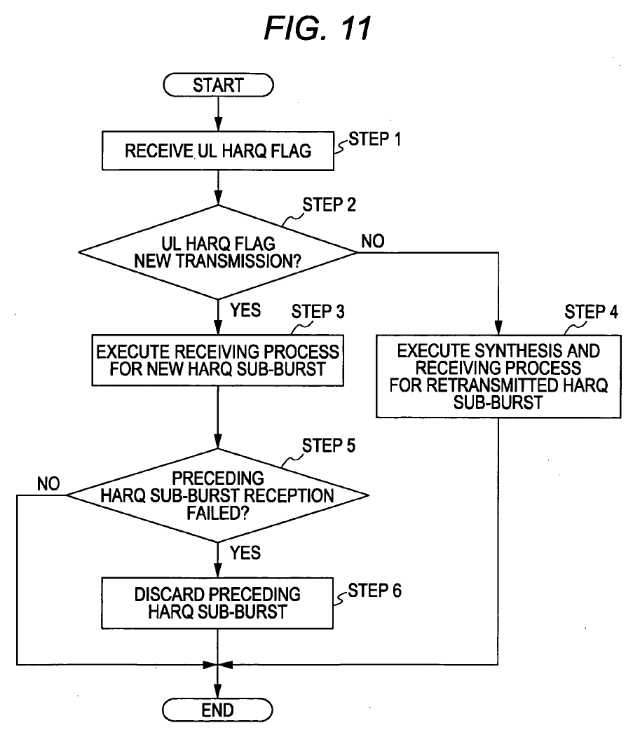

FIG. 11 is an example of the operation flow of the base station.

The base station 30 receives the UL HARQ flag (step 1).

The base station 30 judges whether the designated data is transmitted or not based on UL HARQ flag (step 2). In the case where the new transmission is designated and the control signal C1 (not the control signal C2) is received, the base station 30 judges the answer as YES. In the case where the retransmission is designated and the control signal C2 (not the control signal C1) is received, the base station 30 judges the answer as YES. Otherwise, the base station 30 judges the answer as NO.

Now, in the case where the judgment in step 2 is NO, the base station 30 executes the synthesis and receiving process of the retransmission HARQ sub-burst (step 4). Then, the process is ended and returns to step 1.

In the case where the judgment in step 2 is YES, the base station 30 executes the receiving process of the new HARQ sub-burst (step 3) and judges whether the reception of HARQ sub-burst in the preceding session has ended in a failure or not (step 5).

In the case where the judgment in step 5 is NO, the process is ended and returns to step 1.

In the case where the judgment in step 5 is YES, the HARQ sub-burst received in the preceding session is discarded (the data stored in the storage unit is made deletable or overwritable) and the process returns to step 1.

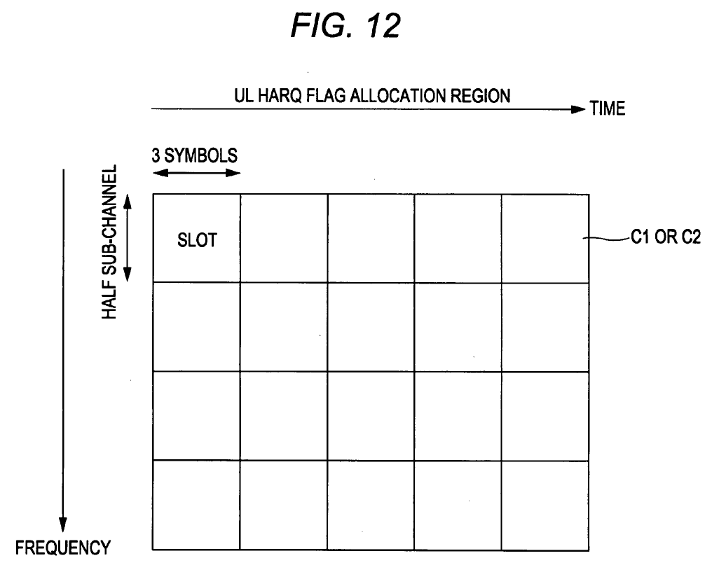

FIG. 12 is an example of the region allocated for transmission of the UL HARQ flag.

In this case, one region for transmitting the control signal is a region shown as a slot. One slot, for example, is assumed to have a subcarrier equivalent to a half subchannel and the time equivalent to three symbols. The control signal C1 or C2 is transmitted in this slot.

In the foregoing explanation, the control signal C1 is used when complying with the designation, and the control signal C2 when not complying with the designation. By using the control signal C1 for new transmission and the control signal C2 for retransmission, however, the base station 30 can detect the data difference from the preceding designation checking the control signals C1 or C2 and the preceding designation of itself.

In the case where a plurality of control signals can be stored in the slot with redundancy, the storage of the plurality of control signals C1 and/or C2 in the slot may be permitted.

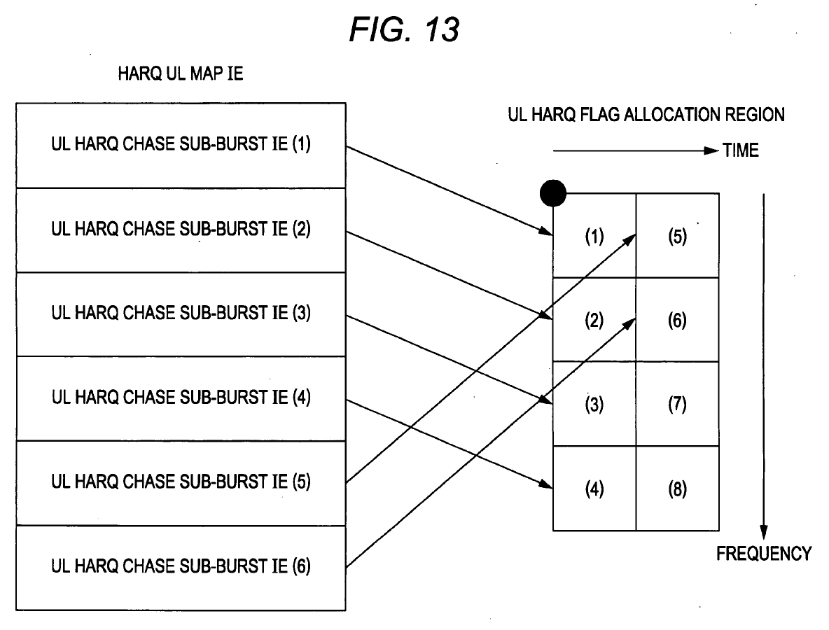

FIG. 13 is an example of the case not expressly designating to each terminal which part (slot) of the control signal transmission region is to be used (the case requiring the calculation).

The terminal 40, upon judgment that the fifth HARQ chase sub-burst IE is addressed to itself, for example, and that the transmission is required, transmits the control signal in the slot corresponding to the fifth control signal area taking advantage of the fact that the fifth UL HARQ chase sub-burst IE is involved.

Specifically, the terminal 40 counts five slots in the upward (or downward) direction of frequency from the starting point (indicated by the black circle) of the designated control signal transmission region.

In this example, a control signal transmission region for only four slots is allocated along the direction of frequency. Thus, the time is increased by one slot and the transmission region of the slot designated by (5) is specified, so that the terminal 40 transmits the control signal in the specified slot (5).

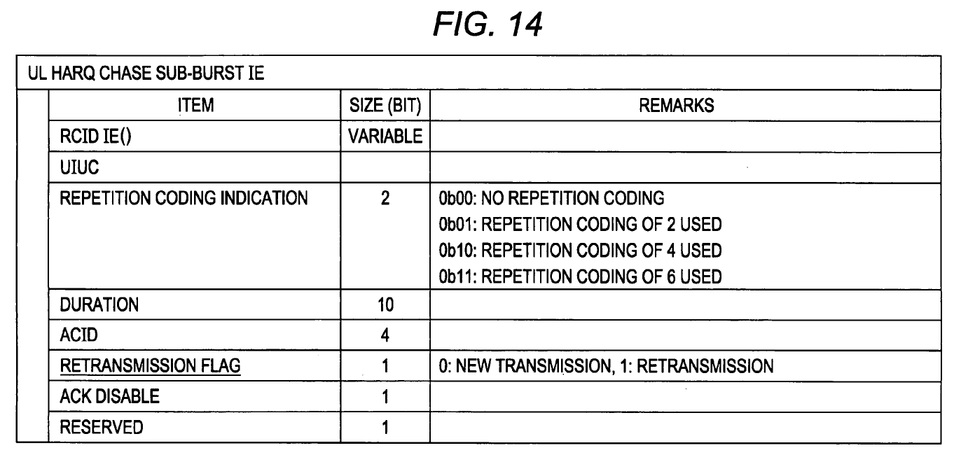

In FIG. 14, the retransmission flag to determine whether the new transmission or the retransmission is required is included in the UL HARQ chase sub-burst IE. AI SN notifies the new transmission or the retransmission according to the bit change. The retransmission flag, on the other hand, can be judged as a new transmission at 0, and as a retransmission at 1.

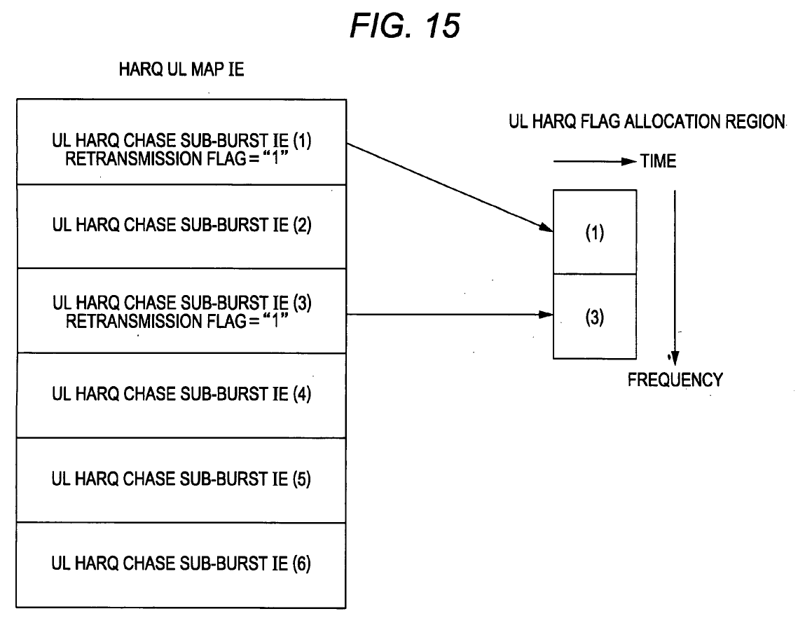

The terminal 40, as shown in FIG. 15, can thus recognize that the slot is used for control signal transmission as long as the retransmission flag assumes the state of 1.

Specifically, each terminal transmits the control signal in the case where the retransmission flag is 1.

The terminal 40, upon detection that the third UL HARQ chase sub-burst IE is addressed to itself, counts the number of UL HARQ chase sub-burst IEs already having the retransmission flag in the state of 1. Since the number is 1, the terminal 40 recognizes that the second slot is to be used and transmits the control signal in the slot designated by (3). In this way, the transmission region for the uplink signal consumed for the control signal is reduced.

According to this embodiment, even in the case where the transmission region and the data to be transmitted in the particular transmission region are designated, the particular transmission region can be used without complying with the particular designation.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication method for a radio communication system including a first radio communication apparatus for designating a transmission region and a second radio communication apparatus for transmitting a radio signal in the designated transmission region,
wherein the first radio communication apparatus designates a transmission region of data and a control signal for the second radio communication apparatus and designates a type of data to be transmitted in the transmission region, and
the second radio communication apparatus transmits, in the designated transmission region, transmission data and a control signal indicating that the transmission data is transmitted in accordance with the designated type of data or that the transmission data is not transmitted in accordance with the designated type of data.

2. The communication method according to claim 1,
wherein the type of data includes control data, user data, voice data, audio data, video data, data high in priority, new data, and retransmission data.

3. The communication method according to claim 1,
wherein the designated type of data is one of new data and retransmission data.

4. The communication method according to claim 1,
wherein the designated type of data is retransmission data, and
the control signal indicates that the transmission data corresponds to the retransmission data or does not correspond to the retransmission data.

5. The communication method according to claim 1,
wherein the transmission region of the data or the control signal is designated for each radio frame by the first radio communication apparatus.

6. The communication method according to claim 1,
wherein the transmission region is designated in such a manner that the data transmission region and the control signal transmission region are designated separately from each other by the first radio communication apparatus.

7. A radio communication apparatus corresponding to a first radio communication apparatus of a radio communication system wherein a second radio communication apparatus transmits a radio signal in a transmission region designated by the first radio communication apparatus, the radio communication apparatus comprising:
a generating unit configured to generate designation information including a designation of the transmission region of data and a control signal for the second radio communication apparatus, and a designation of a type of data to be transmitted in the transmission region;
a transmission unit configured to transmit the designation information generated by the generating unit; and
a receiving unit configured to receive transmission data and a control signal indicating that the transmission data is transmitted in accordance with the designated type or that the transmission data is not transmitted in accordance with the designated type in the designated transmission region from the second radio communication apparatus.

8. A radio communication apparatus corresponding to a second radio communication apparatus of a radio communication system wherein the second radio communication apparatus transmits a radio signal in a transmission region designated by a first radio communication apparatus, the radio communication apparatus comprising:
a receiving unit configured to receive, from the first radio communication apparatus, designation information including a designation of the transmission region of data and a control signal, and a designation of a type of data to be transmitted in the transmission region;
a transmission unit configured to transmit a radio signal to the first radio communication apparatus; and
a control unit configured to control the transmission unit to transmit, in the transmission region designated by the designation information, transmission data, and a control signal indicating that the transmission data is transmitted in accordance with the designated type or that the transmission data is not transmitted in accordance with the designated type.

9. The radio communication apparatus according to claim 8,
wherein the control unit controls the transmission unit to transmit, as the transmission data, other data higher in priority than the designated data, and the control signal indicating that the transmission data is not transmitted in accordance with the data designation.

10. The radio communication apparatus according to claim 8,
wherein the data designation is the designation of retransmission data not correctly received by the first radio communication apparatus, and
in the case where normal transmission of the designated retransmission data is not complete in spite of the fact that a given tolerable delay time is exceeded, the control unit controls the transmission unit to transmit other data as the transmission data on the one hand, and controls the transmission unit to transmit the control signal indicating that the transmission data is not transmitted in accordance with the data designation on the other hand.

11. A communication method for a radio communication system including a first radio communication apparatus for designating a transmission region and a second radio communication apparatus for transmitting a radio signal in the designated transmission region,
wherein the first radio communication apparatus designates a transmission region of data and a control signal for the second radio communication apparatus and designates a transmission scheme to be applied to transmission of the data in the transmission region, and
the second radio communication apparatus transmits, in the designated transmission region, transmission data and a control signal indicating that the transmission data is transmitted in accordance with the designated transmission scheme or that the transmission data is not transmitted in accordance with the designated transmission scheme.

12. A radio communication apparatus corresponding to a first radio communication apparatus of a radio communication system wherein a second radio communication apparatus transmits a radio signal in a transmission region designated by the first radio communication apparatus, the radio communication apparatus comprising:
a generating unit configured to generate designation information including a designation of the transmission region of data and a control signal for the second radio communication apparatus and a designation of transmission scheme to be applied to transmission of the data in the transmission region;
a transmission unit configured to transmit the designation information generated by the generating unit; and
a receiving unit configured to receive transmission data and a control signal indicating that the transmission data is transmitted in accordance with the designated transmission scheme or that the transmission data is not transmitted in accordance with the designated transmission scheme in the designated transmission region from the second radio communication apparatus.

13. A radio communication apparatus corresponding to a second radio communication apparatus of a radio communication system wherein the second radio communication apparatus transmits a radio signal in a transmission region designated by a first radio communication apparatus, the radio communication apparatus comprising:
a receiving unit configured to receive, from the first radio communication apparatus, designation information including a designation of the transmission region of data and a control signal and a designation of a transmission scheme type to be applied to transmission of the data in the transmission region;
a transmission unit configured to transmit a radio signal to the first radio communication apparatus; and
a control unit configured to control the transmission unit to transmit, in the transmission region designated by the designation information, transmission data and a control signal indicating that the transmission data is transmitted in accordance with the designated transmission scheme or that the transmission data is not transmitted in accordance with the designated transmission scheme.
